(19) United States
(12) Patent Application Publication
(10) Pub. No.: US 2026/0066635 A1
(43) Pub. Date: Mar. 5, 2026

(54) MULTIPIECE ENCLOSURE ASSEMBLY

(71) Applicant: Southwire Company, LLC, Carrollton, GA (US)

(72) Inventor: Kyle Curry, Palm Harbor, FL (US)

(21) Appl. No.: 19/307,591

(22) Filed: Aug. 22, 2025

Related U.S. Application Data
(60) Provisional application No. 63/687,580, filed on Aug. 27, 2024.

(51) Int. Cl. H02G 3/08; H02G 3/14; H02G 3/16; H02G 7/00

(52) U.S. Cl. CPC H02G 3/083; H02G 3/14; H02G 3/16; H02G 7/00

(57) ABSTRACT

A multipiece enclosure assembly is provided. The multipiece enclosure assembly may include a base comprising one or more walls and defining an interior configured to house one or more components and surrounded by the one or more walls. The base may have an open top and define a first opening at a front wall of the one or more walls. The open top and the first opening may provide access to the interior of the base to allow for connecting at least a portion of the one or more components to an incoming cable outside of the base. The multipiece enclosure assembly may further include an insert defining a second opening. The insert may be configured for being releasably secured to the base at the first opening. The multipiece enclosure assembly may further include a cover configured for being releasably secured to the base.

### CROSS-REFERENCE TO RELATED APPLICATIONS

This application claims priority to U.S. Provisional Patent Application No. 63/687,580, filed on Aug. 27, 2024, which is incorporated herein by reference in its entirety.

### FIELD OF INVENTION

The present disclosure relates generally to cable enclosures. Example embodiments are directed to multipiece enclosure assemblies, methods of assembling a multipiece enclosure assembly, and systems comprising a multipiece enclosure assembly.

### BACKGROUND

Cables are generally configured and utilized for transmitting power, data, optical signals, and/or electrical signals. Examples of cables include, but are not limited to, electrical cables, optical fiber cables, power cables, and coaxial cables. A cable such as, for example, a trunk cable, may include one or more inner cables. In various applications such as, for example, telecommunication applications (e.g., 5G Telecom), a cable comprising one or more inner cables is often utilized and can be configured for assembly to circuitry disposed within an enclosure. Non-limiting examples of such circuitry include surge protector circuitry, fault detector circuitry, and/or the like. The inner cables are split out from the cable and terminated with one or more connectors configured for connecting the inner cables to the circuitry disposed within the enclosure. These cables can be very heavy and stiff, making assembly of the cables in the enclosure extremely difficult. In particular, the heavy and stiff nature of the cables makes it difficult to route the cable through an opening of the enclosure configured for receiving the cable and/or through a cable gland already installed in the enclosure. This is especially difficult if the installation or repairs are taking place atop a telecommunications tower.

Through applied effort, ingenuity, and innovation, Applicant has solved problems related to enclosures for housing circuitry including, but not limited to, the above noted challenges and problems in existing enclosures.

### BRIEF SUMMARY

According to one aspect of the present disclosure, a multipiece enclosure assembly is provided. In various embodiments, the multipiece enclosure assembly includes a base comprising one or more walls and defining an interior configured to house one or more components and surrounded by the one or more walls, the base having an open top and defining a first opening at a front wall of the one or more walls, wherein the open top and the first opening provide access to the interior of the base to allow for connecting at least a portion of the one or more components to an incoming cable outside of the base; an insert defining a second opening, the insert configured for being releasably secured to the base at the first opening; and a cover configured for being releasably secured to the base.

In some example embodiments, the base defines one or more angled tiers on at least one wall of the one or more walls.

In some example embodiments, the first opening comprises a first portion and a second portion, the first portion configured for receiving the insert.

In some example embodiments, the second portion of the first opening defined by the base and the second opening defined by the insert each have an arc shape.

In some example embodiments, the second portion of the first opening defined by the base and the second opening defined by the insert are configured to surround a cable gland.

In some example embodiments, one or more mounting structures are disposed on an outer facing portion of the cover for mounting the multipiece enclosure assembly to a support structure.

In some example embodiments, the support structure is a telecommunications tower pole.

In some example embodiments, the one or more components comprise at least one component of a circuitry and one or more cable connectors configured for connecting the incoming cable to the circuitry.

In some example embodiments, the one or more cable connectors comprise at least one terminal connector for connecting to an end of one or more inner cables split out from the incoming cable.

In some example embodiments, the circuitry is a surge protector circuitry.

In some example embodiments, the circuitry is a fault detector circuitry.

In some example embodiments, the base and the insert are made from same material.

In some example embodiments, the base is made from rigid material.

In some example embodiments, the cover is made from rigid material.

In some example embodiments, the base and the insert are made from different materials.

According to another aspect of the present disclosure, a method of assembling a cable to a multipiece enclosure assembly is provided. In various embodiments, the method includes passing an incoming cable comprising one or more inner cables through a cable gland positioned outside of the multipiece enclosure assembly, the multipiece enclosure assembly having a base with an open top and defining a top-front opening; connecting the one or more inner cables to one or more terminal connectors; routing, via the open top and the top-front opening of the base, the one or more terminal connectors to an interior of the base; connecting the one or more terminal connectors to a circuitry disposed within the base; positioning the cable gland within the top-front opening defined by the base; securing an insert of the multipiece enclosure assembly to the base, such that the insert and the base surround the cable gland; and securing a cover to the base at the open top.

In some example embodiments, connecting the one or more terminal connectors to the circuitry comprises connecting the one or more terminal connectors to a connector plate disposed with the base.

In some example embodiments, the circuitry comprises a surge protector circuitry for telecommunications equipment.

In some example embodiments, the circuitry comprises a fault detector circuitry.

In some example embodiments, the method further includes mounting the multipiece enclosure assembly to a pole of a telecommunication antenna tower.

### BRIEF DESCRIPTION OF THE DRAWINGS

Reference will now be made to the drawings, which are not necessarily drawn to scale, and wherein:

FIG. 1 shows a top front perspective view of a multipiece enclosure assembly in accordance with at least one embodiment of the present disclosure.

FIG. 2 shows a top front perspective view of a portion of a multipiece enclosure assembly in accordance with at least one embodiment of the present disclosure.

FIG. 3 shows a bottom front perspective view of a partial exploded view of a multipiece enclosure assembly in accordance with at least one embodiment of the present disclosure.

FIG. 4 shows a top side perspective view of an example base of a multipiece enclosure assembly in accordance with at least one embodiment of the present disclosure.

FIG. 5 shows a side view of an example base of a multipiece enclosure assembly in accordance with at least one embodiment of the present disclosure.

FIGS. 6-8 show a top view of a portion of an interior of an example base of a multipiece enclosure assembly in accordance with at least one embodiment of the present disclosure.

FIG. 9 shows an example insert of a multipiece enclosure assembly in accordance with at least one embodiment of the present disclosure.

FIG. 10 shows an example spacer in accordance with at least one embodiment of the present disclosure.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout.

Various embodiments of the present disclosure are directed to a multipiece enclosure assembly, a method of assembling a multipiece enclosure assembly, and a system comprising a multipiece enclosure assembly. The multipiece enclosure assembly may be utilized in a variety of applications and environments. As a non-limiting example, the multipiece enclosure assembly may be utilized in telecommunications (e.g., 5G Telecom). A telecommunication network, for example, may include an antenna tower and a base station housing certain equipment. A multipiece enclosure assembly may be disposed at the antenna tower (or other location) and configured to connect an incoming cable routed from the base station to circuitry disposed within an enclosure and/or to outgoing cables routed to telecommunications equipment (e.g., antenna equipment, radio equipment, or the like) at the top of the antenna tower. In some embodiments, the circuitry disposed within the multipiece enclosure assembly may comprise a surge protector circuitry, a fault detector circuitry (e.g., overvoltage detection, or the like), and/or the like.

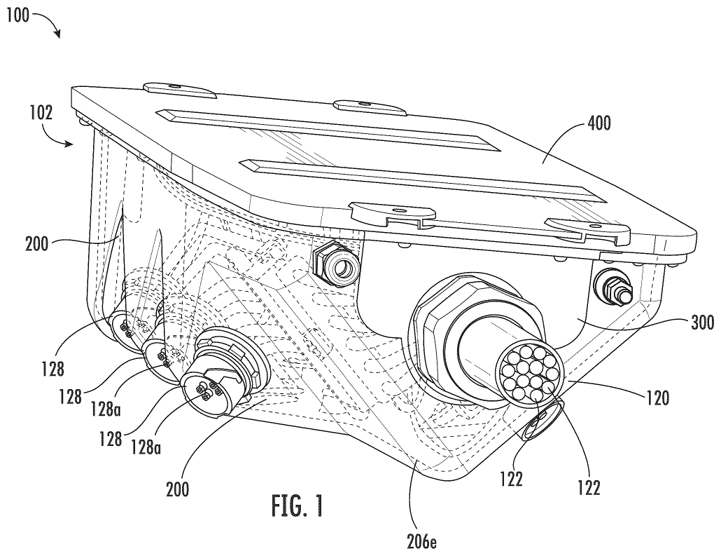

FIGS. 1-3 show different views of a multipiece enclosure assembly 100 in accordance with at least one embodiment of the present disclosure. The multipiece enclosure assembly 100 is configured to house one or more components (e.g., electrical components, optical components, fiber optic components, and/or the like). In some embodiments, at least a portion of the one or more components comprise components of a surge protector circuitry (e.g., telecommunications surge protector circuitry or any other surge protector circuitry), a fault detector circuitry, and/or the like.

In some embodiments, the multipiece enclosure assembly 100 may function at least in part for protecting the components disposed within the multipiece enclosure assembly 100 from environmental conditions and/or to mitigate safety hazards. Alternatively or additionally, in some embodiments, the multipiece enclosure assembly 100 may function at least in part for connecting one or more incoming cables (e.g., inner cables thereof) to one or more outgoing cables. Alternatively or additionally, in some embodiments, the multipiece enclosure assembly 100 may function at least in part for connecting one or more incoming cables (e.g., inner cables thereof) to a surge protector circuitry, a fault detector circuitry, and/or other circuitry housed within the multipiece enclosure assembly 100.

In some embodiments, the incoming cable is connected to one or more distribution cables disposed within the multipiece enclosure assembly 100. The distribution cables may be configured for routing power, fiber optical signals, and/or the like from the incoming cable to circuitry disposed within the multipiece enclosure assembly 100 and/or to one or more outgoing cables. For example, the incoming cable may include one or more inner cables such as electrical cables, fiber optic cables, and/or the like. The one or more inner cables may be split out at the portion of the incoming cable disposed within the multipiece enclosure assembly 100 and coupled to one or more cables (referred to herein as distribution cables) disposed within the multipiece enclosure assembly 100. In some embodiments, the one or more inner cables are connected to the one or more distribution cables via one or more cable connectors.

In some embodiments, the outgoing cables are connected to an electrical distribution system, an equipment, and/or the like. In some embodiments, the one or more distribution cables are connected to the one or more outgoing cables via one or more cable connectors. In some embodiments, the one or more distribution cables are connected to a surge protector circuitry, a fault detector circuitry, and/or other circuitry disposed within the multipiece enclosure assembly 100 or may comprise a portion of the circuitry.

The multipiece enclosure assembly 100 solves various challenges associated with assembling an incoming cable (e.g., one or more inner cables thereof) to circuitry disposed within an enclosure. These cables can be very heavy and stiff, making assembly of the cables in the enclosure extremely difficult. In particular, the heavy and stiff nature of the cables makes it difficult to route the cable through an opening of the enclosure configured for receiving the cable and/or through a cable gland already installed in the enclosure. This is especially difficult if the installation or repairs are taking place atop a telecommunications tower.

The configuration of the multipiece enclosure assembly 100 (as further described below) according to various embodiments of the present disclosure allows for these cables to be assembled in a manner that does not require feeding the cables through an opening or a cable gland already installed to the enclosure before assembling to the circuitry disposed within the enclosure. Example embodiments of the present disclosure allow for assembling the cables to at least some of the components configured for being disposed within the enclosure. In particular, example embodiments allow coupling of the incoming cable to cable connectors outside of the multipiece enclosure assembly 100 (e.g., as opposed to coupling within the enclosure) before disposing the same (e.g., cable connectors connected to incoming cable) within the multipiece enclosure assembly 100. The multipiece enclosure assembly 100 includes discrete components configured to be decoupled from each other to enable such assembly and facilitate efficient assembly of incoming cables to circuitry disposed within the multipiece enclosure assembly 100. In this regard, the multipiece enclosure assembly 100 reduces assembly time, reduces human effort, and improves overall efficiency associated with assembling circuitry disposed within the enclosure to incoming cables. In some embodiments, the multipiece enclosure assembly 100 may be modular.

FIG. 1 shows a top front perspective view of an example multipiece enclosure assembly 100 in accordance with at least one embodiment of the present disclosure. Specifically, the multipiece enclosure assembly 100 is shown in FIG. 1 with a portion of the incoming cable 120 coupled to the multipiece enclosure assembly 100. The incoming cable 120 may include one or more inner cables 122. For example, the incoming cable 120 may comprise a sheath (or other outer covering) surrounding one or more inner cables 122. The one or more inner cables 122 may be configured for carrying power, data signals, and/or the like. The one or more inner cables 122 may comprise one or more electrical cables such as, for example, power cables, coaxial cables, twisted pair cables, and/or the like. Alternatively or additionally, the one or more inner cables 122 may comprise one or more fiber optic cables. Alternatively or additionally, the one or more inner cables 122 may comprise one or more hybrid cables.

In an example embodiment, the incoming cable 120 comprises one or more electrical cables 122a (e.g., one or more power conductors that transmit power, one or more data cables that transmit data signals, and/or the like), one or more optical cables 122b (e.g., each optical cable comprising one or more optical fibers that transmit optical signals), and/or one or more ground cables 122c. In an example embodiment, the incoming cable 120 is a trunk cable comprising one or more inner cables 122 used to transmit power and/or data with optical and/or electrical signals. It would be appreciated that the incoming cable 120 may comprise any combination of a variety of inner cables.

The inner cables 122 are split out at one end of the incoming cable 120 (e.g., the inner cables 122 are exposed such that they extend outwardly from the outer covering) to connect, directly or indirectly, to circuitry disposed within an enclosure (such as multipiece enclosure assembly 100) and/or to outgoing cables. Outgoing cables may refer to cables that connect the circuitry disposed within the multipiece enclosure assembly to electrical distribution systems and/or equipment. Examples of such equipment include, but are not limited, to power and/or data communications equipment.

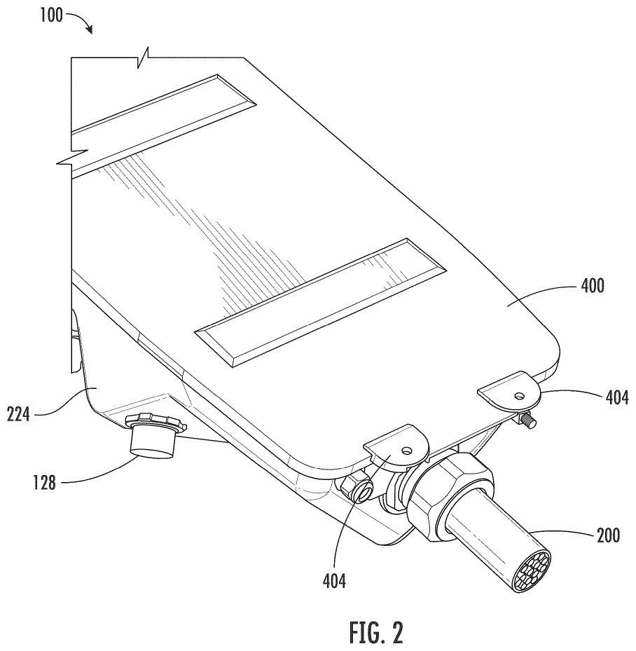

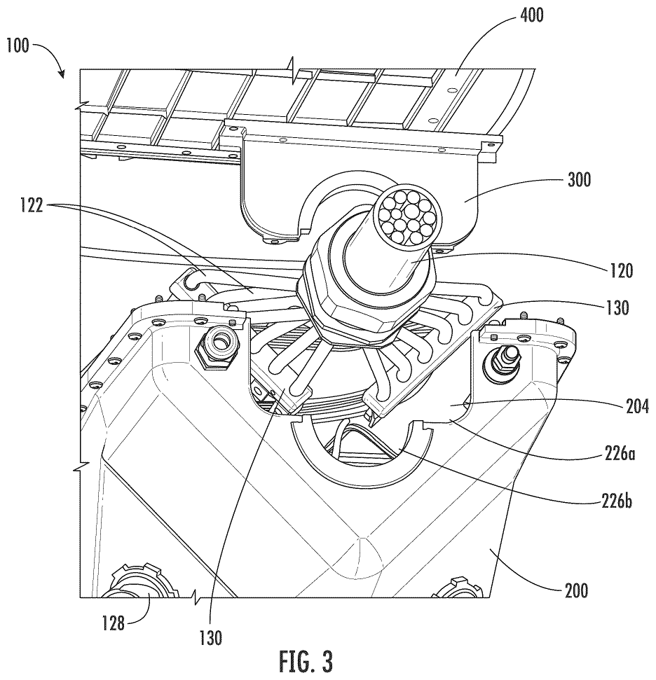

FIG. 2 shows a top front perspective view of a portion of a multipiece enclosure assembly 100 in accordance with at least one embodiment of the present disclosure. FIG. 3 shows a bottom front perspective view of a partial exploded view of a multipiece enclosure assembly 100 in accordance with at least one embodiment of the present disclosure. The multipiece enclosure assembly 100 is shown in FIGS. 2 and 3 with an incoming cable 120 (e.g., portion thereof) disposed within the multipiece enclosure assembly 100.

As shown in FIGS. 1-3, the multipiece enclosure assembly 100 comprises a housing 102. The housing 102 comprises a base 200, an insert 300, and a cover 400. In various embodiments, the base 200, insert 300, and cover 400 are discrete components of the housing 102 and are each configured for being releasably secured to at least one other component of the housing 102. In various embodiments, the cover 400 is configured for being removably secured to the base 200. In various embodiments, the insert 300 is configured for being removably secured to the base 200. In various embodiments, the insert 300 is configured to fit within an opening defined by the base 200. In an example embodiment, the cover 400 and the insert 300 are integrally formed. In such example embodiment, the cover 400 and the insert 300 may collectively form a single member of the multipiece enclosure assembly 100 configured for being removably secured to the base 200.

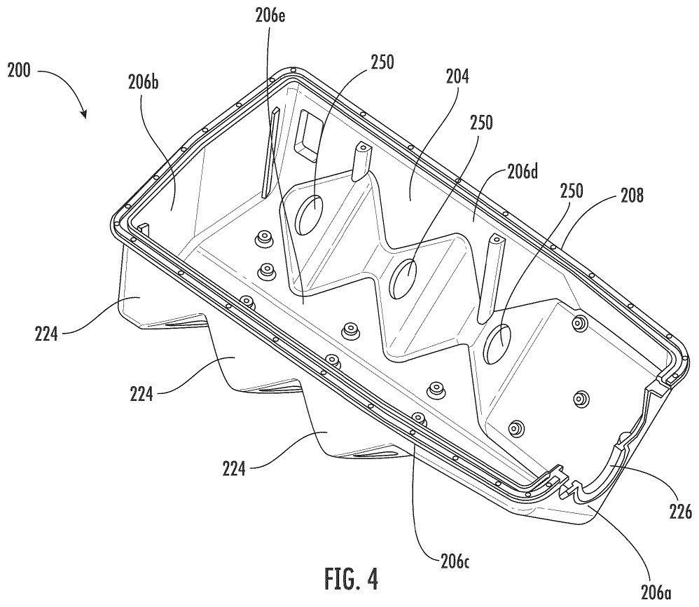

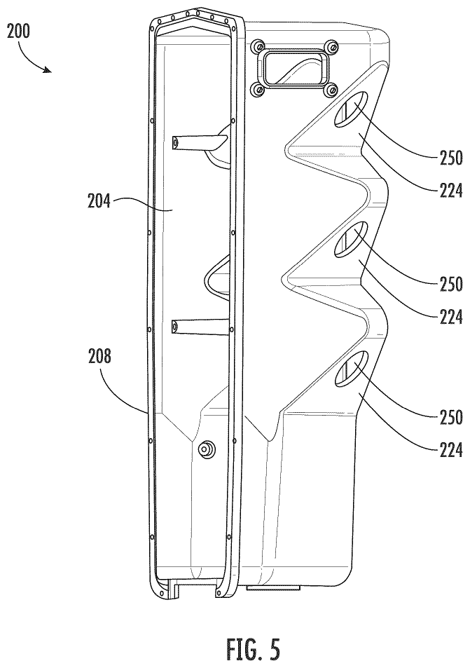

FIG. 4 shows a top side perspective view of an example base 200 in accordance with at least one embodiment of the present disclosure. FIG. 5 shows a side view of an example base 200 in accordance with at least one embodiment of the present disclosure. The base 200 has an open top 208 and defines an interior 204 surrounded by one or more walls. The example base 200 depicted in FIGS. 4-5 includes a front wall 206a, a rear wall 206b, a left side wall 206c, a right side wall 206d, and a bottom wall 206e surrounding the interior 204 or otherwise defining the interior 204. The number of walls of the base 200 may depend on the shape of the base 200. For example, a base 200 having a square shape or rectangular shape may have five walls. As another example, a base 200 having a hexagonal shape may have seven walls. As yet another example, a base 200 having a circular shape may have two walls (e.g., a continuous side wall and a bottom wall).

The base 200 is configured to house one or more components within the interior 204 defined by the base 200. In various embodiments, the one or more components comprise components of a circuitry (e.g., surge protector circuitry, fault detector circuitry, and/or the like). Additionally the one or more components may comprise components configured to facilitate connection of the circuitry to incoming cable or outgoing cable. For example, in some embodiments, the one or more components may include one or more distribution cables (e.g., electrical cables, fiber optic cables, or the like), one or more bus bars (e.g., input power bus bar, return power bus bar, and/or the like), one or more relays, one or more cable connectors, one or more circuitry boards and/or the like. It would be appreciated that the base 200 may be configured to house various components that may include additional components and/or omit some of the components described above.

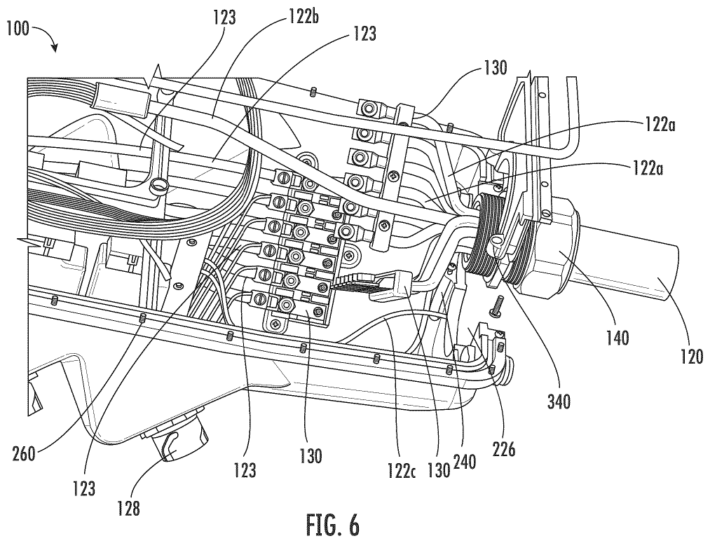

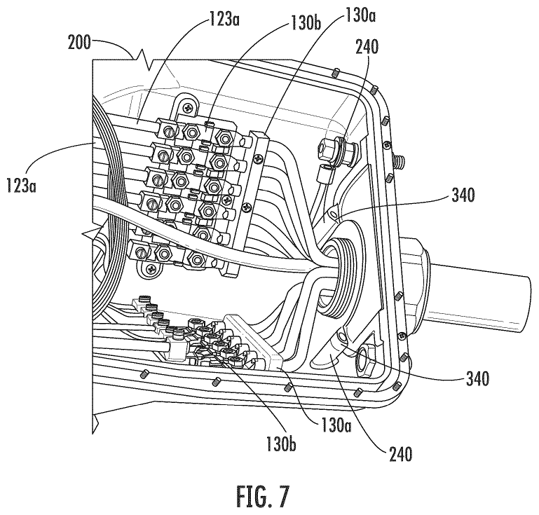

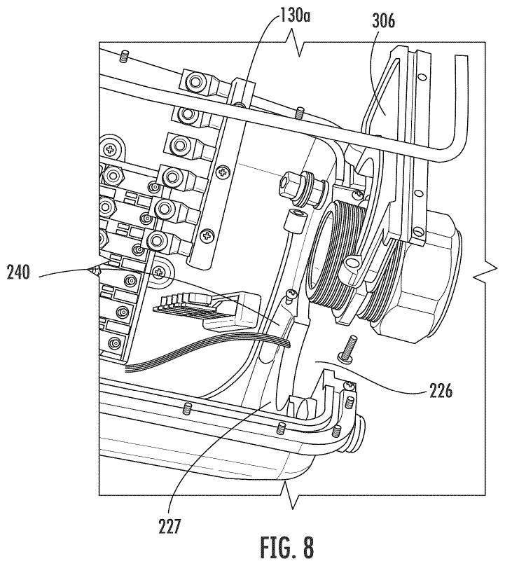

FIGS. 6-8 each show a top view of a portion of the interior 204 of an example base 200 in accordance with at least one embodiment of the present disclosure. Specifically, the example base 200 is shown in FIGS. 6-8 with various components housed therein. In various embodiments, at least a portion of the components is configured for connecting an incoming cable 120 (e.g., one or more inner cables 122 thereof) to one or more cables (distribution cables 123) disposed within the base 200. Specifically, in some embodiments, at least a portion of the components include cable connectors 130 (also referred to herein as interior cable connectors) configured for connecting inner cables 122 split out from the incoming cable 120 to one or more distribution cables 123. The one or more cable connectors 130 may comprise terminal connectors, terminal plates, adapters, and/or other elements configured for connecting (e.g., electrically and/or mechanically) two or more cables together. In an example embodiment, as shown in FIG. 7, the inner cables 122 are connected to a terminal connector 130a of one or more terminal connectors 130a. The terminal connectors 130a may each be connected to respective connector plate 130b. One or more distribution cables 123 are connected to the connector plates 130b to connect the inner cables 122 to the one or more distribution cables 123.

In some embodiments, the one or more distribution cables 123 may correspond to the one or more inner cables 122. In some embodiments, the one or more distribution cables 123 comprise one or more electrical cables such as for example, power cables, coaxial cables, twisted pair cables, and/or the like. Alternatively or additionally, the one or more distribution cables 123 may comprise one or more fiber optic cables. Alternatively or additionally, the one or more distribution cables 123 may comprise one or more hybrid cables. In an example embodiment, the one or more distribution cables 123 comprise one or more electrical cables 123a (e.g., one or more power conductors that transmit power, one or more data cables that transmit data signals, and/or the like), one or more optical cables (e.g., each optical cable comprising one or more optical fibers that transmit optical signals), and/or one or more ground cables. It would be appreciated that the one or more distribution cables 123 may comprise any combination of cable types.

In various embodiments, the base 200 defines one or more openings 250. The one or more openings 250 (or a portion thereof) may be configured to receive one or more cable connectors, such as adapter 128. For example, one or more adapters 128 may be disposed at the one or more openings 250. In some embodiments, an adapter 128 disposed at an opening 250 may have a portion thereof disposed within the interior 204 of the base 200. For example, an adapter 128 disposed at an opening 250 may extend through the opening 250, such that the opening 250 surrounds a portion of the adapter 128.

The one or more adapters 128 may be configured for connecting (e.g., electrically, or the like) the circuitry disposed within the multipiece enclosure assembly 100 to outgoing cables. In some embodiments, the circuitry may be connected via at least a portion of the one or more distribution cables 123. For example, a first end of a distribution cable 123 may be connected to a first end of an adapter 128 and an end of an outgoing cable (not shown) may be connected to a second end of the adapter 128. In an example embodiment, an adapter 128 may comprise a connection interface 128a configured to provide quick connection and disconnection of outgoing cables to the adapter 128. In some embodiments, an adapter 128 may not comprise such connection interface 128a. In some embodiments, an adapter 128 may include one or more power terminals for connecting to electrical cables and/or one or more fiber optic terminals for connecting to fiber optic cables.

In various embodiments, the adapters 128 are positioned at an angle relative to the plane (e.g., central axis) defined by the base 200 and facing downwards to, for example, alleviate strain on the cables (e.g., outgoing cable or distribution cable) connected thereto and/or to enhance cable routing. In some embodiments, each adapter 128 (or a portion of the adapters 128) is positioned at a 45-degree angle relative to the plane defined by the base 200. It would be appreciated that the adapters can be positioned at other angles that may be less or greater than 45 degrees.

In various embodiments, the base 200 defines or otherwise includes one or more angled tiers 224. In some embodiments, the angled tiers 224 (or a portion thereof) are angled at 45-degrees relative to the plane defined by the base 200. It would be appreciated that the angled tiers 224 may be angled at less or greater than 45 degrees in other embodiments. The angled tiers of the base 200 may define the one or more openings 250. In this regard, each of the one or more angled tiers 224 (or a portion of the one or more angled tiers 224) may be configured to retain or otherwise support an adapter 128 disposed thereon. Each adapter 128 may extend outwardly relative to the exterior of the angled tier 224. The one or more angled tiers 224 may be disposed along one or more walls of the base 200. In some embodiments, at least a portion of the one or more angled tiers 224 is disposed along one or both of the side walls 206c, 206d of the base 200. Alternatively or additionally, in some embodiments, at least a portion of the one or more angled tiers 224 is disposed along one or both of the rear wall 206b or the bottom wall 206e.

In an example embodiment, the base 200 includes three angled tiers 224 along the left side wall 206c of the base 200 and three angled tiers 224 along the right side wall 206d of the base 200. Each angled tier 224 in the base 200 according to such example embodiment defines an opening 250 and may include an adapter 128 disposed at each opening 250 or otherwise configured to receive an adapter 128 at each opening 250. It would be appreciated that in other embodiments, the base 200 may define more or less than six angled tiers 224 and/or more or less than three angled tiers on each side wall 206c, 206d.

In various embodiments, the base 200 defines an opening 226. In various embodiments, the opening 226 is defined in a front portion of the base 200, such as the front wall 206a. In various embodiments, the opening 226 is a top-front opening in that the opening 226 extends to the open top 208 of the base 200. In this regard, the top-front configuration of the opening 226 allows for assembling an incoming cable 120 (e.g., inner cables 122 thereof) to one or more cable connectors 130 (and/or to other components) outside of the multipiece enclosure assembly 100 (e.g., outside of the base 200) to facilitate connection of the incoming cable 120 (e.g., inner cables 122 thereof) to the circuit (e.g., via one or more distribution cables 123) disposed within the base 200 of the multipiece enclosure assembly 100. In this regard, the top-front configuration of the opening 226 (e.g., along with the open top configuration of the base 200) provides unrestricted access to the interior 204 of the base 200.

The opening 226 is configured to receive the insert 300 such that the insert 300 may be releasably secured to the base 200. In various embodiments, the opening 226 includes a first portion 226a (e.g., upper opening) and a second portion 226b (e.g., lower opening). The first portion 226a is configured for receiving the insert 300. The first portion 226a is configured such that the insert 300 fits within the first portion 226a at least when the multipiece enclosure assembly 100 is in an assembled configuration. For example, the first portion 226a may be dimensioned, shaped, and/or the like such that the insert 300 fits within the first portion 226a. In various embodiments, the first portion 226a has a shape that corresponds to a shape of the insert 300 to enable the base 200 and the insert 300 to mate.

In various embodiments, the second portion 226b of the opening 226 is configured for receiving or at least in part supporting a cable entry device 140 (e.g., cable gland, a cable connector, a cable fitting, or the like). The cable entry device 140 may be configured for receiving the incoming cable 120 or otherwise routing the incoming cable 120 therethrough an opening defined by the cable entry device, such that the cable entry device 140 surrounds at least a portion of the incoming cable 120. Alternatively or additionally, the cable entry device 140 may be configured to provide strain relief for the incoming cable 120 (e.g., one or more inner cables 122 thereof).

The second portion 226b may have any suitable shape, which may or may not depend on the application or other components of the multipiece enclosure assembly 100. In some embodiments, the second portion 226b has an arc shape. In some embodiments, the second portion 226b has a “U” shape. In some embodiments, the second portion 226b has an oval shape. In some embodiments, the second portion 226b has a square shape. In some embodiments, the second portion 226b has an irregular shape. It would be appreciated that the above are provided as non-limiting example shape profiles of the second portion 226b. The second portion 226b may have any suitable shape, as described above.

In some embodiments, the shape of the second portion 226b may depend at least in part on the shape of the cable entry device 140. In some embodiments, the shape of the second portion 226b may depend at least in part on the shape of the incoming cable 120 (e.g., where a cable entry device 140 is not utilized). In some embodiments, the shape of the second portion 226b may depend at least in part on the shape of a spacer surrounding the cable entry device (e.g., in example embodiments where a spacer is utilized) or incoming cable 120 (e.g., in example embodiments where a spacer is utilized, and a cable entry device is not utilized).

For example, the second portion 226b may have a shape that allows for the portion of the base 200 along the second portion 226b to conform to at least a portion of the cable entry device 140. As another example, the second portion 226b may have a shape that allows for the portion of the base 200 along the second portion 226b to conform to at least a portion of the incoming cable (e.g., where a cable entry device is not utilized). As yet another example, the second portion 226b may have a shape that allows for the portion of the base 200 along the second portion 226b to conform to at least a portion of a spacer (e.g., in example embodiments where a spacer is utilized). In an example embodiment, the portion of the base 200 along the second portion 226b may be made from flexible and/or elastic material such that the insert may conform to any shape of a cable entry device 140, incoming cable 120, spacer, or the like.

In some embodiments, the base 200 defines one or more holes 260 along the perimeter of the top portion of the base 200. The one or more holes 260 may be configured for receiving one or more fasteners (e.g., screws, nuts, bolts, pegs, and/or the like) to releasably secure the cover 400 to the base 200. It would be appreciated that in some other embodiments, the base 200 may include or define other attachment mechanisms for releasably securing the cover 400 to the base 200.

The base 200 may be formed from any of a plurality of materials that can support the components disposed within the interior 204 of the base 200. In some embodiments, the base 200 is made from rigid material such as rigid plastic, metal, or the like. In some embodiments, the base 200 is made from flexible material. In some embodiments, the base 200 is made from semi flexible material. In some embodiments, the base 200 is made from transparent material. In some embodiments, the base 200 is made from semi-transparent material. In some embodiments, the base 200 is made from opaque material.

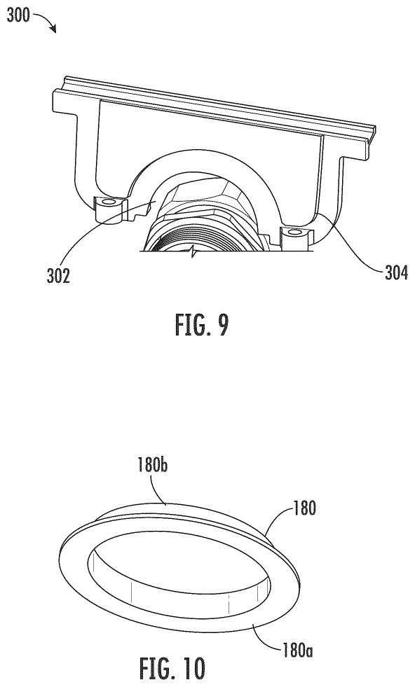

FIG. 9 shows an example insert 300 in accordance with at least one embodiment of the present disclosure. In various embodiments, the insert 300 comprises a body 304 defining an opening 302. In various embodiments, the body 304 is a rigid body. In some embodiments, the body 304 is a semi-rigid body. In some embodiments, the body 304 is a flexible body. For example, in some embodiments, the insert 300 may be made from rigid material such as rigid plastic, metal, or the like. In some embodiments, the insert 300 may be made from flexible material. In some embodiments, the insert 300 may be made from semi flexible material. In some embodiments, the insert 300 may be made from transparent material. In some embodiments, the insert 300 may be made from semi-transparent material. In some embodiments, insert 300 may be made from opaque material. It would be appreciated that the insert 300 may be formed from any of a plurality of materials.

The opening 302 defined by the insert 300 may have any suitable shape, which may or may not depend on the application or other components of the multipiece enclosure assembly 100. In some embodiments, the opening 302 has an arc shape. In some embodiments, the opening 302 has a “U” shape. In some embodiments, the opening 302 has an oval shape. In some embodiments, the opening 302 has a square shape. In some embodiments, the opening 302 has an irregular shape. It would be appreciated that the above are provided as non-limiting example shape profiles of the opening 302. The insert 300 may define an opening 302 having any suitable shape, as described above.

In various embodiments, the opening 302 is configured to fit over at least a portion of a cable entry device, such as cable entry device 140 and/or a spacer (e.g., in embodiments, where a spacer is utilized). In some embodiments, the shape of the opening 302 may depend at least in part on the shape of the cable entry device 140. In some embodiments, the opening 302 is configured to fit over at least a portion of an incoming cable such as incoming cable 120 (e.g., where a cable entry device is not utilized). In some embodiments, the shape of the opening 302 may depend at least in part on the shape of the incoming cable 120. In some embodiments, the shape of the opening 302 may depend at least in part on the shape of a spacer surrounding the cable entry device 140 (e.g., in example embodiments where a spacer is utilized) or surrounding the incoming cable 120 (e.g., in example embodiments, where such spacer is utilized and a cable entry device 140 is not utilized).

For example, the opening 302 may have a shape that allows for the portion of the insert 300 along the opening 302 to conform to at least a portion of the cable entry device 140. As another example, the opening 302 may have a shape that allows for the portion of the insert 300 along the opening 302 to conform to at least a portion of the incoming cable (e.g., where a cable entry device is not utilized). As yet another example, the opening 302 may have a shape that allows for the portion of the insert 300 along the opening 302 to conform to at least a portion of a spacer (e.g., where a spacer is utilized). In an example embodiment, the insert 300 (or a portion thereof) may be made from flexible and/or elastic material such that the insert may conform to any shape of a cable entry device 140, incoming cable 120, spacer, or the like.

In various embodiments, the opening 302 has a shape that corresponds to the shape of the second portion 226b defined by the base 200. In an example embodiment, the opening 302 has an arc shape and the second portion 226b of the opening 226 has an arc shape having an orientation that is opposite the orientation of the arc shape of the opening 302. In various embodiments, the insert 300 (e.g., including the opening 302 thereof) and the base 200 (e.g., including the second portion 226b thereof) are configured to align when the insert is inserted into the opening 226 of the base 200, such that they form or otherwise collectively define an opening to support, retain or otherwise surround the incoming cable 120 and/or other devices (e.g., cable entry device 140, spacer, or the like). In some embodiments, a spacer may be disposed within the opening, such that the cable entry device 140 is surrounded by the spacer.

FIG. 10 shows an example spacer 180 in accordance with at least one embodiment of the present disclosure. The spacer 180 may be interchangeable such that various sizes of cable entry devices 140 and/or incoming cable 120 may be used. The spacer 180 may be positioned within the opening defined by the insert 300 and the base 200 such that a portion 180a of the spacer 180 is disposed in the interior of the base 200 and a neck portion 180b of the spacer extends outward from the interior of the base 200. In some embodiments, the cable entry device 140 and/or spacer 180 may be components (e.g., discrete components of the multipiece enclosure assembly 100). In some embodiments, the shape of the opening 302 and the shape of the second portion 226b may be the same. In some embodiments, the shape of the opening 302 and the shape of the second portion 226b may be different from each other.

The insert 300 may be secured to the base 200 via or more fastening mechanisms and/or techniques. In an example embodiment, the base 200 includes a set of one or more attachment members 240 and the insert 300 includes a set of one or more attachment members 340 that corresponds to the set of one or more attachment members 240 of the base 200. Additionally, the set of one or more attachment members 240 of the base 200 and the set of one or more attachment members 340 of the insert 300 may be positioned at the base 200 and insert 300, respectively, such that the set of one or more attachment members 240 of the base 200 aligns with the set of one or more attachment members 340 of the insert 300 when the insert 300 is inserted within the opening 226 defined by the base 200 (e.g., within the first portion 226a).

In an example embodiment, and as shown in FIG. 6-8, the set of one or more attachment members 240 of the base 200 includes a pair of attachment members 240 positioned at an inner facing side 227 of the wall defining the opening 226 (e.g., front wall of the base 200 in various embodiments) and extending outwardly therefrom towards the interior 204 of the base 200. Each of the pair of attachment members 240 defines a hole (e.g., a threaded hole, non-threaded hole, or the like) for receiving a fastener (e.g., a screw, bolts, pegs, and/or the like). Additionally, the set of one or more attachment members 340 of the insert 300 includes a pair of attachment members 340 positioned at an inner facing side 306 of the insert 300 and extending outwardly therefrom towards the interior 204 of the base 200. Each of the pair of attachment members 340 defines a hole (e.g., a threaded hole, non-threaded hole or the like) for receiving a fastener (e.g., a screw, a bolt, or the like). The pair of attachment members 240 and the pair of attachment members 340 are positioned such that holes defined by the pair of attachment members 240 align with the holes defined by the pair of attachment members 340 when the insert 300 is inserted into the opening 226 defined by the base 200 to allow for a fastener to be disposed within corresponding holes. It would be appreciated that the insert 300 may be secured to the base 200 using any of a plurality of fastening mechanisms and/or techniques (e.g., adhesives, anchors, rivets, or the like). In addition, gaskets or seals or the like may be used between the insert 300 and any adjoining surfaces to ensure the enclosure is weathertight.

The cover 400 may be formed from any of a plurality of materials. In some embodiments, the cover 400 is made from rigid material such as rigid plastic, metal, or the like. In some embodiments, the cover 400 is made from flexible material. In some embodiments, the cover 400 is made from semi flexible material. In some embodiments, the cover 400 is made from transparent material. In some embodiments, the cover 400 is made from semi-transparent material. In some embodiments, the cover 400 is made from opaque material.

In various embodiments, the cover 400 is configured for being secured to the base 200 at the open top of the base 200. In various embodiments, the cover 400 is configured such that it extends at least the length and width of the base 200. In various embodiments, the cover 400 includes one or more attachment members 404 configured for releasably securing the cover 400 to the base 200 at the top portion of the base 200. In some embodiments, at least a portion of the one or more attachment members 404 defines a hole (e.g., a threaded hole, non-threaded hole or the like) for receiving a fastener (e.g., a screw, a bolt, peg, and/or the like). It would be appreciated that the cover 400 may be configured for being secured to the base 200 using any of a variety of attachment mechanisms or techniques. In addition, gaskets or seals or the like may be used between the cover 400 and any adjoining surfaces to ensure the enclosure is weathertight.

In some embodiments, the multipiece enclosure assembly 100 includes one or more mounting members (not shown) configured for mounting or otherwise attaching the multipiece enclosure assembly 100 to a support structure such as, for example, a pole. In some embodiments, the mounting member(s) comprises a clamp, bracket, and/or the like. In some embodiments, the mounting member(s) are configured to receive a clamp, bracket, and/or the like for securing the multipiece enclosure assembly 100 to a support structure. In some embodiments, the mounting member(s) is disposed on the cover 400. In some embodiments, the multipiece enclosure assembly 100 is configured for being installed to a tower such as an antenna tower. The tower may include a pole to which the multipiece enclosure assembly 100 is attached using the one or more mounting members (mounting structure(s)).

The multipiece enclosure assembly 100 solves various challenges associated with connecting an incoming cable (e.g., one or more inner cables thereof) to the circuitry disposed within an enclosure. In particular, various embodiments of the present disclosure provide a method of connecting an incoming cable to circuitry disposed with an enclosure such as the multipiece enclosure assembly 100 in a manner that does not require feeding the incoming cable through an opening or a cable entry device (e.g., cable gland, or the like) already installed to the enclosure.

In various embodiments, an incoming cable may be passed through a cable entry device (e.g., cable gland, or the like) outside of the multipiece enclosure assembly (e.g., as opposed to passing the incoming cable through a cable entry device installed to an enclosure). The incoming cable may include one or more inner cables split out from the incoming cable. One or more terminal connectors may be connected to the inner cables outside of the multipiece enclosure assembly 100. The terminal connectors may be configured to terminate the inner cables at the exposed end of the inner cables and for connecting to a circuitry disposed within the multipiece enclosure assembly 100. For example, a terminal connector may be configured for connecting to an end of one or more inner cables split out from an incoming cable and for connecting to a circuitry disposed within the multipiece enclosure assembly 100.

After connecting the inner cables to the one or more terminal connectors, the terminal connectors with the connected inner cables may be routed via the open top and/or top-front opening of the base of the multipiece enclosure assembly 100 such that the terminal connectors and a portion of the incoming cable is positioned above or within the interior of the base of the multipiece enclosure assembly 100.

The one or more terminal connectors may then be connected to the circuitry disposed within the interior of the base of the multipiece enclosure assembly 100. The circuitry, for example, may be a surge protector circuitry, a fault detector circuitry, or any other circuitry that can benefit from being housed within an enclosure. In various embodiments, the one or more terminal connectors may be connected to the circuitry via at least one connector plate secured to and within the base of the multipiece enclosure assembly or otherwise disposed within the interior of the base of the multipiece enclosure assembly 100. The connector plate, for example, may be pre-assembled to the circuitry disposed within the interior of the base of the multipiece enclosure assembly 100 and may be configured to electrically connect the one or more inner cables to the circuitry. In some embodiments, the connectors plate(s) are pre-assembled to the circuitry via one or more distribution cables associated with the circuitry (e.g., one or more cables of the circuitry).

After connecting the one or more terminal connectors to the connector plate(s), the cable entry device (e.g., surrounding at least a portion of the incoming cable) may be positioned within the front opening defined by the base of the multipiece enclosure assembly. In particular, the cable entry device may be positioned within a lower portion of the opening (e.g., second portion 226b).

After positioning the cable entry device within the front opening defined by the base of the multipiece enclosure assembly 100, the insert of the multipiece enclosure assembly 100 may be positioned over the cable entry device and releasably secured to the base of the multipiece enclosure assembly. In some embodiments, the insert may be secured to the base using fasteners such as screws, bolts, nuts, and/or the like. By providing a multipiece enclosure assembly having an insert that can be separated from the base such that the base defines an opening that extends to the open top of the base, embodiments of the present disclosure obviate the need to feed the incoming cable and/or terminal connector through an opening in order to connect to the circuitry (e.g., surge protector circuitry, fault detector circuitry, and/or the like) within the enclosure. In this regard, embodiments of the present disclosure at least facilitate efficient assembly of a circuitry housed within the enclosure to the incoming cable by obviating the need to feed the cables through an opening.

After securing the insert to the base, the cover of the multipiece enclosure assembly 100 may be releasably secured to the base. In some embodiments, the cover may be secured to the base of the multipiece enclosure using fasteners such as screws, bolts, nuts, and/or the like.

In some embodiments, the multipiece enclosure assembly may be mounted to a support structure. In some embodiments the support structure may be a pole, such as a pole of a telecommunications antenna tower. The multipiece enclosure assembly may be mounted to the support structure such that the adapters (e.g., connection interface thereof) are facing downward. For example, the multipiece enclosure assembly may be mounted perpendicularly to the support structure such that the front portion of the multipiece enclosure assembly (e.g., front wall) is facing downwardly. In some embodiments, one or more outgoing cables may be connected to the adapters and routed to an electrical distribution system and/or one or more equipment. Non-limiting examples of such equipment include telecommunications equipment.

In some embodiments, a system comprising a multipiece enclosure assembly may comprise an incoming cable such as incoming cable 120, a multipiece enclosure assembly such as multipiece enclosure assembly 100, and/or one or more outgoing cables. In some embodiments, the system further includes a surge protector circuitry, a fault detector circuitry, and/or other circuitry disposed within the multipiece enclosure assembly.

1. A multipiece enclosure assembly comprising:
a base comprising one or more walls and defining an interior configured to house one or more components and surrounded by the one or more walls, the base having an open top and defining a first opening at a front wall of the one or more walls, wherein the open top and the first opening provide access to the interior of the base to allow for connecting at least a portion of the one or more components to an incoming cable outside of the base;
an insert defining a second opening, the insert configured for being releasably secured to the base at the first opening; and
a cover configured for being releasably secured to the base.

2. The multipiece enclosure assembly of claim 1, wherein the base defines one or more angled tiers on at least one wall of the one or more walls.

3. The multipiece enclosure assembly of claim 1, wherein the first opening comprises a first portion and a second portion, the first portion configured for receiving the insert.

4. The multipiece enclosure assembly of claim 3, wherein the second portion of the first opening defined by the base and the second opening defined by the insert each have an arc shape.

5. The multipiece enclosure assembly of claim 3, wherein the second portion of the first opening defined by the base and the second opening defined by the insert are configured to surround a cable gland.

6. The multipiece enclosure assembly of claim 1, wherein one or more mounting structures are disposed on an outer facing portion of the cover for mounting the multipiece enclosure assembly to a support structure.

7. The multipiece enclosure assembly of claim 6, wherein the support structure is a telecommunications tower pole.

8. The multipiece enclosure assembly of claim 1, wherein the one or more components comprise at least one component of a circuitry and one or more cable connectors configured for connecting the incoming cable to the circuitry.

9. The multipiece enclosure assembly of claim 8, wherein the one or more cable connectors comprise at least one terminal connector for connecting to an end of one or more inner cables split out from the incoming cable.

10. The multipiece enclosure assembly of claim 8, wherein the circuitry is a surge protector circuitry.

11. The multipiece enclosure assembly of claim 8, wherein the circuitry is a fault detector circuitry.

12. The multipiece enclosure assembly of claim 1, wherein the base and the insert are made from same material.

13. The multipiece enclosure assembly of claim 1, wherein the base is made from rigid material.

14. The multipiece enclosure assembly of claim 1, wherein the cover is made from rigid material.

15. The multipiece enclosure assembly of claim 1, wherein the base and the insert are made from different materials.

16. A method of assembling a cable to a multipiece enclosure assembly, the method comprising:
passing an incoming cable comprising one or more inner cables through a cable gland positioned outside of the multipiece enclosure assembly, the multipiece enclosure assembly having a base with an open top and defining a top-front opening;
connecting the one or more inner cables to one or more terminal connectors;
routing, via the open top and the top-front opening of the base, the one or more terminal connectors to an interior of the base;
connecting the one or more terminal connectors to a circuitry disposed within the base;
positioning the cable gland within the top-front opening defined by the base;
securing an insert of the multipiece enclosure assembly to the base, such that the insert and the base surround the cable gland; and
securing a cover to the base at the open top.

17. The method of claim 16, wherein connecting the one or more terminal connectors to the circuitry comprises connecting the one or more terminal connectors to a connector plate disposed with the base.

18. The method of claim 17, wherein the circuitry comprises a surge protector circuitry for telecommunications equipment.

19. The method of claim 17, wherein the circuitry comprises a fault detector circuitry.

20. The method of claim 16, further comprising:
mounting the multipiece enclosure assembly to a pole of a telecommunication antenna tower.
